(19) United States
(12) Patent Application Publication
(10) Pub. No.: US 2009/0305635 A1
(43) Pub. Date: Dec. 10, 2009

(54) PACKAGING MATERIAL WITH ELECTROMAGNETIC COUPLING MODULE

(75) Inventors: Makoto OSAMURA, Mukou-shi (JP); Norio SAKAI, Moriyama-shi (JP); Noboru KATO, Moriyama-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/536,669

(22) Filed: Aug. 6, 2009

Related U.S. Application Data
(63) Continuation of application No. PCT/JP2008/050356, filed on Jan. 15, 2008.

(30) Foreign Application Priority Data
Feb. 6, 2007 (JP) 2007-026460

(51) Int. Cl. H04B 7/00

(52) U.S. Cl. 455/41.2

(57) ABSTRACT

A packaging material with an electromagnetic coupling module for a RFID system, is constructed such that a radio IC chip is protected from external shock and environmental change without adversely affecting the planarity of the packaging material, the assembly of a radiator and an electromagnetic coupling module is facilitated, and the radiation characteristics are satisfactory. A packaging material includes a liner and a wave-shaped core material, wherein an electromagnetic coupling module and a radiator that are electromagnetically coupled to each other are arranged inside of the packaging material. The electromagnetic coupling module includes a radio IC chip and a feeder circuit board, on which the radio IC chip is mounted, the feeder circuit board including a resonant circuit that includes an inductance element. The radiator electromagnetically couples with the electromagnetic coupling module to transmit/receive high frequency signals.

### BACKGROUND OF THE INVENTION

1. Field of the Invention

The present invention relates to packaging materials with electromagnetic coupling modules, and more particularly, to a packaging material including an electromagnetic coupling module having a radio IC chip used in an RFID (Radio Frequency Identification) system.

2. Description of the Related Art

Recently, RFID systems, in which a reader/writer that generates an induction field contactlessly communicates with an IC chip (also referred to as an IC tag and a radio IC chip) that is attached to an article or a container and stores predetermined information to exchange information, have been developed as article management systems. For example, Japanese Unexamined Patent Application Publication No. 2003-26177 discloses a packaging body having an antenna unit and an IC chip that are electrically conductive and provided on an outer surface of a cardboard box. Covering the IC chip with another surface to protect the IC chip is also described.

However, attaching the antenna unit and the IC chip on an outer surface of the packaging body has a problem of being easily influenced by an external environment, and furthermore, areas having increased thicknesses which define attachment areas produced, whereby accurate stacking, such as when stacking and storing the packaging bodies, becomes difficult. When another article contacts the projecting IC chip, the IC chip may be damaged by the shock. The antenna unit and the IC chip need to be arranged to overlap each other in an electrically conductive manner. Since the displacement in the overlapping state causes trouble during transmission and reception of signals, a highly accurate arrangement is required. Furthermore, the radiation characteristics during transmission and reception may not be sufficient since the antenna unit is relatively small.

### SUMMARY OF THE INVENTION

To overcome the problems described above, preferred embodiments of the present invention provide a packaging material including an electromagnetic coupling module that is suitable for an RFID system, in which the radio IC chip is protected from external shock and environmental changes without affecting the planarity of the packaging material, the assembly of the radiator and the electromagnetic coupling module is facilitated, and the radiation characteristics are satisfactory.

A preferred embodiment of the present invention provides a packaging material with an electromagnetic coupling module including a packaging material including a sheet-shaped liner, and a wave-shaped core material connected to the liner, an electromagnetic coupling module including a radio IC chip and a feeder circuit board, on which the radio IC chip is mounted, the feeder circuit board including a resonant circuit that includes an inductance element and has a predetermined resonant frequency, and a radiator that is electromagnetically coupled to the feeder circuit board, wherein the radiator is arranged inside of the packaging material, and the electromagnetic coupling module is arranged on the radiator or adjacent to the radiator inside of the packaging material.

In the packaging material with the electromagnetic coupling module according to a preferred embodiment of the present invention, the electromagnetic coupling module includes the radio IC chip and the feeder circuit board, and the electromagnetic coupling module and the radiator are electromagnetically coupled. Since the electromagnetic coupling module and the radiator are not directly electrically coupled but are electromagnetically coupled, the electromagnetic coupling module and the radiator operate even if the electromagnetic coupling module is provided adjacent to the radiator other than being provided on the radiator. The electromagnetic coupling module does not need to be highly accurately arranged with respect to the radiator, and the arrangement process is significantly simplified.

The radio IC chip is protected from external shock and environmental changes without affecting the planarity of the packaging material, since the electromagnetic coupling module and the radiator are arranged inside of the packaging material. The frequency of the transmission signal radiated from the radiator and the frequency of the reception signal supplied to the radio IC chip are preferably substantially determined by the resonant frequency of the resonant circuit in the feeder circuit board, various shapes of the radiator can preferably be used, and a stable frequency characteristic can be obtained, whereby the radiation characteristics are satisfactory.

In the packaging material including the electromagnetic coupling module according to a preferred embodiment of the present invention, the radiator may preferably be defined by a conductor having linear shape, a wire shape, or thin-film shape, for example. The radiator may preferably be arranged in a direction parallel or substantially parallel to the waveform of the core material or may preferably be arranged in a direction perpendicular or substantially perpendicular to the waveform of the core material, for example.

The radiator and the electromagnetic coupling module can be arbitrarily arranged as long as they are arranged inside of the packaging material, and for example, the radiator may be arranged on one surface of the core material and the electromagnetic coupling module may be arranged on the other surface or may be arranged at a recessed portion of the core material. Furthermore, the radiator may preferably be interwoven into the core material or may preferably be arranged inside of the liner, for example.

The radio IC chip may preferably store various kinds of information regarding the contents of the packaging material attached with the electromagnetic module. The information may be rewritable. The radio IC chip may preferably have an information processing function other than that for the RFID system.

According to a preferred embodiment of the present invention, a radio IC chip is protected from external shock and environmental changes without affecting the planarity of the packaging material, high accuracy is not required when connecting the radiator and the electromagnetic coupling module, and the assembly thereof is facilitated since the radiator and the electromagnetic coupling module are arranged inside of the packaging material. The electromagnetic coupling module and the radiator are electromagnetically coupled, an arbitrary shape of the radiator may preferably be used, the radiation characteristics are satisfactory, and a stable frequency characteristic is obtained.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIGS. 1A to 1C are sectional views showing a packaging material according to preferred embodiments of the present invention, where FIG. 1A shows a first preferred embodiment of the present invention, FIG. 1B shows a first modified example thereof, and FIG. 1C shows a second modified example thereof.

FIG. 2 is a perspective view of the packaging material according to the first preferred embodiment of the present invention shown in FIG. 1A.

FIGS. 3A to 3F are perspective views showing various shapes of a radiator.

FIG. 4 is a sectional view showing an electromagnetic coupling module.

FIG. 5 is an equivalent circuit diagram of the electromagnetic coupling module.

FIG. 6 is an exploded perspective view showing a feeder circuit board.

FIGS. 7A and 7B are perspective views showing a connection state of a radio IC chip and the feeder circuit board.

FIG. 8 is a sectional view showing a second preferred embodiment of a packaging material according to the present invention.

FIG. 9 is a perspective view of the packaging material of the second preferred embodiment shown in FIG. 8.

FIG. 10 is a sectional view showing a third preferred embodiment of a packaging material according to the present invention.

FIG. 11 is a sectional view showing a fourth preferred embodiment of a packaging material according to the present invention.

FIG. 12 is a sectional view showing a fifth preferred embodiment of a packaging material according to the present invention.

FIG. 13 is a sectional view showing a sixth preferred embodiment of a packaging material according to the present invention.

FIG. 14 is a sectional view showing a seventh preferred embodiment of a packaging material according to the present invention.

### DETAILED DESCRIPTION OF PREFERRED EMBODIMENTS

Preferred embodiments of a packaging material with an electromagnetic coupling module according to the present invention will be described below with reference to the accompanying drawings. In each figure, the same reference numerals are used to denote common components and portions, and redundant description will not be provided.

### First Preferred Embodiment

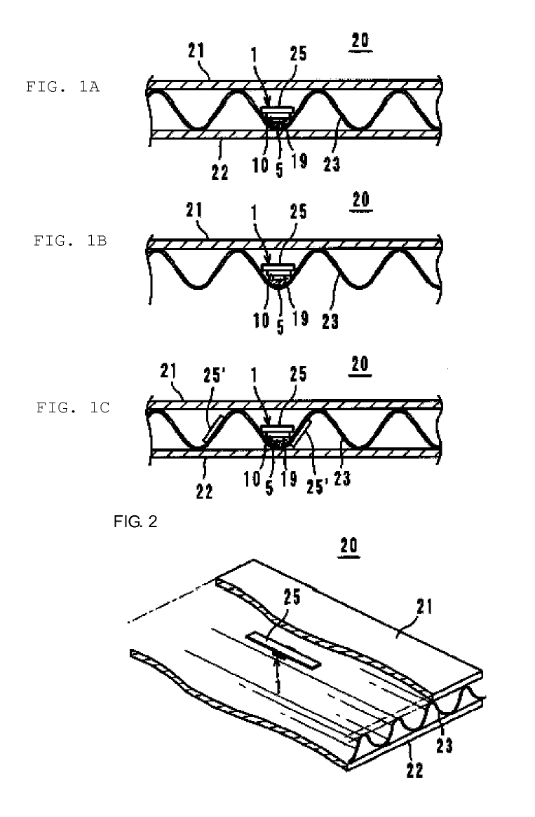

FIG. 1A shows a first preferred embodiment of a packaging material with an electromagnetic coupling module according to the present invention, where a packaging material 20 is preferably a cardboard box, for example, and includes front and back liners 21 and 22, and a core material 23, which preferably has a waveform (corrugated) cross-section, disposed between the liners 21 and 22. The packaging material 20 may preferably include the liner 21 on the upper side and the core material 23, as shown in FIG. 1B, for example.

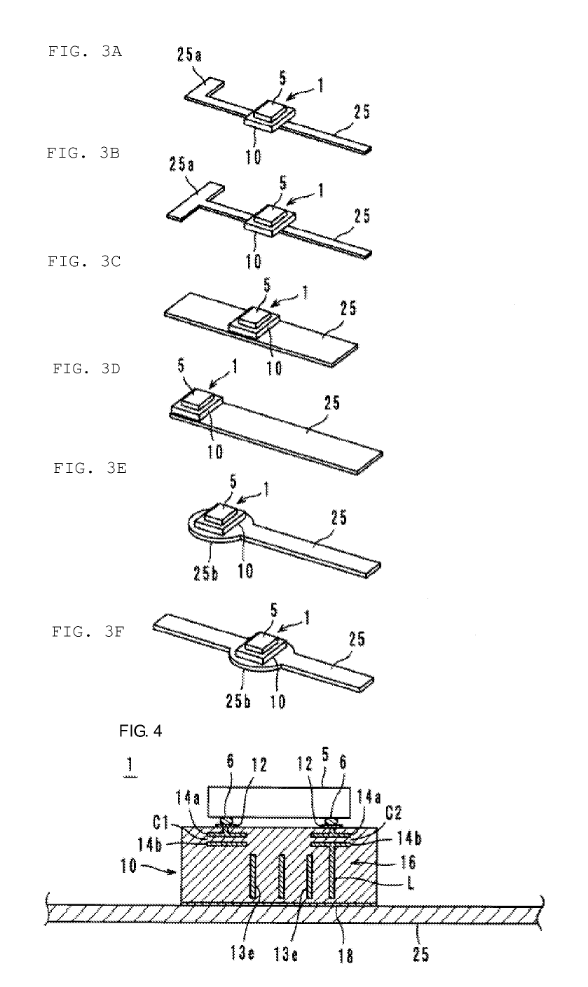

An electromagnetic coupling module 1 including a radio IC chip 5 and a feeder circuit board 10, on which the radio IC chip 5 is mounted, is preferably attached to a recessed portion of the waveform of the core material 23 with an adhesive 19 interposed therebetween, and a radiator 25 preferably having a thin-film shape made of a conductive material is attached to the module 1 with an adhesive 18 interposed therebetween (see FIG. 4). The radiator 25 preferably includes a metal plating film of aluminum foil, copper foil, Al, Cu, Ag, for example, provided on a thin plate or a wire made of conductive material or a resin film, and is preferably arranged in a direction parallel or substantially parallel to a ridge portion of the waveform of the core material 23. As shown in FIG. 1C, a plurality of radiators 25′ may preferably be arranged near the electromagnetic module 1 in the packaging material 20, for example. The adhesive 19 preferably has an insulation property, and is preferably made of a material having high dielectric constant, for example.

The radiator 25 may preferably include a key-shaped portion 25a at one end of an elongated linear body, as shown in FIGS. 3A and 3B, or may preferably be a sheet-shaped body having the same or substantially the same width as the electromagnetic coupling module 1, as shown in FIGS. 3C and 3D. The radiator 25 may also preferably include an attachment portion 25b with respect to the electromagnetic coupling module 1, as shown in FIGS. 3E and 3F. Since the electromagnetic coupling module 1 and the radiator 25 are electromagnetically coupled, as will be described below, the radiator 25 may preferably have any suitable shape, such as a wire shape, for example, or at least the portion facing the electromagnetic coupling module may preferably have a mesh shape, for example.

### Electromagnetic Coupling Module

As shown in FIG. 4, the electromagnetic coupling module 1 preferably includes the radio IC chip 5 and the feeder circuit board 10 on which the radio IC chip 5 is mounted. The radio IC chip 5 includes a clock circuit, a logic circuit, a memory circuit, and other suitable components, stores necessary information, and is electrically connected to a resonant circuit 16 included in the feeder circuit board 10 with metal bumps 6 interposed therebetween. Au, solder, and other suitable materials, for example, can be preferably used for the metal bump 6.

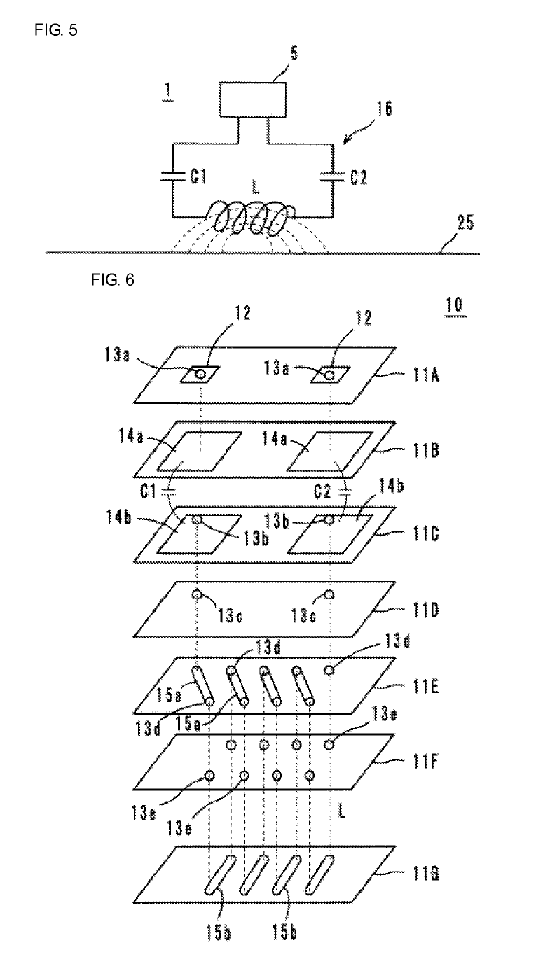

The resonant circuit 16 is arranged to supply the radiator 25 with a transmission signal having a predetermined frequency, and/or a circuit arranged to select a reception signal having a predetermined frequency from signals received by the radiator 25 and to supply the radio IC chip 5 with the selected signal, the resonant circuit 16 resonating at a predetermined frequency. As shown in FIG. 4 and FIG. 5, the resonant circuit 16 is defined by a lumped-constant LC series resonant circuit including a helical inductance element L and capacitance elements C1 and C2.

Specifically, as shown in FIG. 6, the feeder circuit board 10 is preferably formed by stacking, pressure bonding, and firing ceramic sheets 11A to 11G including a dielectric, and includes a sheet 11A that includes a connection electrode 12 and a via hole conductor 13a, a sheet 11B that includes a capacitor electrode 14a, a sheet 11C that includes a capacitor electrode 14b and a via hole conductor 13b, a sheet 11D that includes a via hole conductor 13c, a sheet 11E that includes a conductor pattern 15a and a via hole conductor 13d, a sheet 11f (one or more) that includes a via hole conductor 13e, and a sheet 11G that includes a conductor pattern 15b. Each ceramic sheet 11A to 11G may preferably be made of ceramic material of a magnetic body, for example, and the feeder circuit board 10 can be easily obtained through a multi-layer substrate fabricating step, such as a sheet stacking method or a thick film printing method, for example.

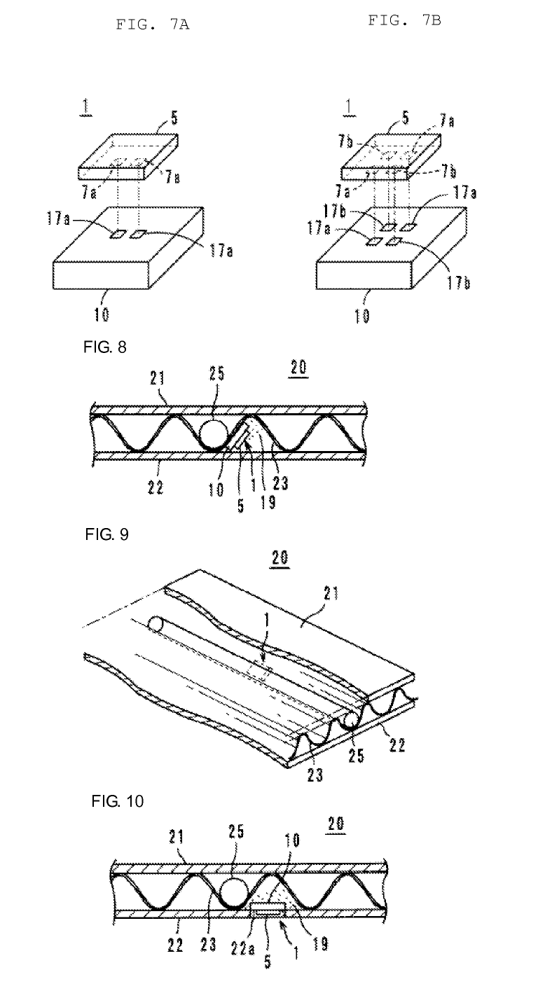

When the sheets 11A to 11G are stacked, the inductance element L in which a helical winding axis is parallel or substantially parallel to the radiator 25, and the capacitance elements C1 and C2 in which the capacitor electrode 14b is connected to both ends of the inductance element L and the capacitor electrode 14a is connected to the connection electrode 12 through the via conductor 13a are provided. The connection electrode 12, which is preferably a substrate side electrode pattern, is preferably electrically connected with a terminal (see FIGS. 7A and 7B) of the radio IC chip 5 with the metal bump 6 interposed therebetween.

In other words, of the elements defining the resonant circuit, the transmission signal is supplied from the inductance element L, which is preferably a coil-shaped electrode pattern, for example, to the radiator 25 through the magnetic field, and the reception signal is supplied from the radiator 25 to the inductance element L through the magnetic field. Thus, in the feeder circuit board 10, the inductance element L is preferably arranged so as to be in the vicinity of the radiator 25 of the inductance element L and the capacitance elements C1 and C2 defining the resonant circuit 16.

FIGS. 7A and 7B show a connection configuration of the radio IC chip 5 and the feeder circuit board 10. In FIG. 7A, a pair of antenna (balanced) terminals 7a and 17a is preferably provided on the back surface of the radio IC chip 5 and the front surface of the feeder circuit board 10, respectively. FIG. 7B shows another connection configuration, in which ground terminals 7b and 17b are respectively provided on the back surface of the radio IC chip 5 and the front surface of the feeder circuit board 10, in addition to the pair of antenna (balanced) terminals 7a and 17a. The ground terminal 17b of the feeder circuit board 10 is preferably terminated, and is not connected to other elements of the feeder circuit board 10.

FIG. 5 shows an equivalent circuit of the electromagnetic coupling module 1. The electromagnetic coupling module 1 receives the high frequency signal (e.g., UHF frequency band) radiated from the reader/writer (not shown) with the radiator 25, resonates the resonant circuit 16 (LC series resonant circuit including inductance element L and capacitance elements C1 and C2) primarily magnetically coupled with the radiator 25, and supplies the radio IC chip 5 with only a reception signal of a predetermined frequency band. The predetermined energy is output from such a reception signal, and the information stored in the radio IC chip 5 is preferably adjusted to match a predetermined frequency in the resonant circuit 16 with the energy as a driving source, and thereafter, the transmission signal is transmitted from the inductance element L to the radiator 25 through magnetic coupling and then transmitted and transferred from the radiator 25 to the reader/writer.

The coupling of the resonant circuit 16 and the radiator 25 is preferably primarily a coupling through a magnetic field, but may also be a coupling through an electric field. In preferred embodiments of the present invention, “electromagnetic coupling” refers to the coupling through an electric field and/or a magnetic field.

In the resonant circuit 16, the resonant frequency characteristic is determined by the resonant circuit defined by the inductance element L and the capacitance elements C1 and C2. The resonant frequency of the signal radiated from the radiator 25 is substantially determined by the self-resonant frequency of the resonant circuit 16. Therefore, a radiator 25 having any suitable shape can be used, and the relative position of the electromagnetic coupling module 1 with respect to the radiator 25 is arbitrary. Therefore, the attachment position of the electromagnetic coupling module 1 does not need to be controlled with very high accuracy.

Furthermore, the coil-shaped electrode pattern defining the inductance element L is preferably arranged such that the winding axis is parallel or substantially parallel to the radiator 25, and thus, has an advantage in that the center frequency does not fluctuate. As the capacitance elements C1 and C2 are disposed at the post-stage of the radio IC chip 5, the surge of low frequency can preferably be cut with the elements C1 and C2, and the radio IC chip 5 can be protected from the surge.

The resonant circuit 16 also functions as a matching circuit arranged to match the impedance of the radio IC chip 5 and the impedance of the radiator 25. The feeder circuit board 10 may preferably include a matching circuit, including an inductance element and a capacitance element, provided separately from the resonant circuit 16. If the function of the matching circuit is provided by the resonant circuit 16, the design of the resonant circuit 16 tends to become complicated. If the matching circuit is provided separately from the resonant circuit 16, the resonant circuit and the matching circuit can be independently designed.

According to the first preferred embodiment described above, since the radiator 25 and the electromagnetic coupling module 1 are arranged inside of the packaging material 20, the radio IC chip 5 can be protected from external shock and environmental changes without adversely affecting the planarity of the packaging material 20. Furthermore, since the frequency of the transmission/reception signal is substantially determined by the resonant frequency of the resonant circuit 16 of the feeder circuit board 10, high accuracy is not required when arranging the radiator 25 and the electromagnetic coupling module 1, and the assembly thereof is facilitated. Moreover, the electromagnetic coupling module 1 and the radiator 25 are electromagnetically coupled, an arbitrary shape of the radiator 25 may be used, the radiation characteristics are satisfactory, and a stable frequency characteristic can be obtained.

### Second Preferred Embodiment

As shown in FIGS. 8 and 9, the second preferred embodiment of the present invention includes a radiator 25 that preferably has a wire shape and is made of conductive material that is arranged at the recessed portion of the waveform of the core material 23, and an electromagnetic coupling module 1 is attached to the core material 23 with the adhesive 19 and is arranged adjacent to the radiator 25. The electromagnetic coupling module 1 of the second preferred embodiment of the present invention is coupled to the radiator 25 through a magnetic field generated by the inductance element L in the feeder circuit board 10. Thus, the electromagnetic coupling module 1 and the radiator 25 can preferably be arranged to be spaced apart from one another. In the matching circuit of the feeder circuit board 10, the matching conditions are preferably set based on the dielectric constant of the core material 23, for example. The effects and advantages of the second preferred embodiment are similar to the first preferred embodiment.

### Third Preferred Embodiment

As shown in FIG. 10, the third preferred embodiment of the present invention includes a radiator 25 that has a wire shape made of conductive material and arranged at a recessed portion of the core material 23, an electromagnetic coupling module 1 arranged in a hole 22a provided at a position adjacent to the radiator 25 of the liner 22, and the electromagnetic coupling module 1 is attached with the adhesive 19. The effects and advantages of the third preferred embodiment are similar to the first preferred embodiment.

### Fourth Preferred Embodiment

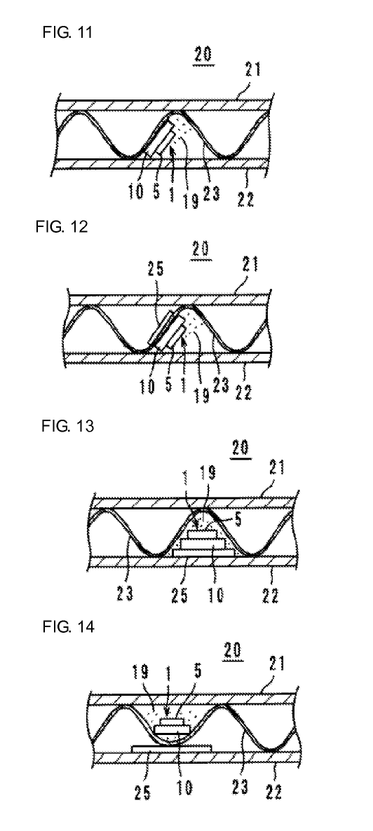

As shown in FIG. 11, the fourth preferred embodiment describes interweaving a plurality of thread-shaped conductive materials (not shown) in the core material 23 when fabricating the core material 23, and forming a band-shaped radiator on the surface and in the interior of the core material 23, wherein the thread-shaped conductive materials are preferably interwoven in a direction parallel or substantially parallel to a ridge portion of the core material 23 or in a direction perpendicular or substantially perpendicular to the ridge portion of the core material 23. In the fourth preferred embodiment, the portion at which the thread-shaped conductive material is interwoven preferably functions as the radiator, and the electromagnetic coupling module 1 is preferably attached to the interwoven portion with the adhesive 19. The effects and advantages of the fourth preferred embodiment are similar to the first preferred embodiment.

### Fifth Preferred Embodiment

As shown in FIG. 12, the fifth preferred embodiment of the present invention describes arranging a thin-film or thick-film radiator 25 on one surface of the core material 23, and fixing the electromagnetic coupling module 1 on the other surface with the adhesive 19. The radiator 25 in the fifth preferred embodiment can preferably be formed at the same time that the core material 23 is fabricated. That is, the radiator 25 having a desired shape is preferably formed on the substantially flat plate-shaped core material by printing of conductive paste, for example. The predetermined core material 23 can preferably then be obtained by forming the radiator 25 on the core material 23. The radiator 25 can be easily formed through printing, for example, and thus, can be fabricated in any suitable shape, such as a rectangle or a circle, for example, may be arranged parallel or substantially parallel to or perpendicular or substantially perpendicular to the waveform, or may be arranged in an intersecting manner, such as in a cross shape, for example. A plurality of the radiators 25 may preferably be provided. With the desired shape and number of the radiators 25, the radiation characteristics of the radiator 25 can be improved, the communicable distance for the RFID can be increased, and the communicable range can be increased. Other effects and advantages of the fifth preferred embodiment are similar to the first preferred embodiment.

### Sixth Preferred Embodiment

As shown in FIG. 13, the sixth preferred embodiment of the present invention describes fixing the electromagnetic coupling module 1 connected to the radiator 25 at the recessed portion of the core material 23 inside of the liner 22 with the adhesive 19. The radiator 25 may preferably be formed by printing conductive paste, for example, inside of the liner 22. The effects and advantages of the sixth preferred embodiment are similar to the first preferred embodiment.

### Seventh Preferred Embodiment

As shown in FIG. 14, the seventh preferred embodiment of the present invention describes arranging the radiator 25 between the liner 22 and the projecting portion of the core material 23, and fixing the electromagnetic coupling module 1 at the recessed portion of the waveform of the core material 23 facing the radiator 25 with the adhesive 19. The radiator 25 may preferably be formed by printing conductive paste, for example, inside of the liner 22. The effects and advantages of the seventh preferred embodiment are similar to the first preferred embodiment.

The packaging material with the electromagnetic coupling module according to the present invention is not limited to the above-described preferred embodiments, and can be variously changed within the scope of the present invention.

In particular, a paper cardboard box is described preferably as the packaging material attached with the electromagnetic coupling module and the radiator in each preferred embodiment described above. However, the packaging material may preferably be made of resin, for example. The details of the internal configuration of the feeder circuit board and the detailed shape of the radiator can be arbitrarily selected, and the feeder circuit board may preferably be made with a flexible material, for example. Furthermore, processes other than the metal bump bonding may be used to connect the radio IC chip onto the feeder circuit board.

In each preferred embodiment shown in FIG. 8 and FIGS. 10 to 14, the electromagnetic coupling module may preferably be arranged with the radio IC chip facing the radiator side. The radiator is arranged parallel or substantially parallel to or perpendicular or substantially perpendicular to the waveform of the core material in each preferred embodiment. However, is not particularly limited to such a configuration, and may preferably be arranged diagonal to the waveform or may preferably be arranged in a substantially cross-shape in plan view.

As described above, preferred embodiments of the present invention are useful for the packaging material with the electromagnetic coupling module, and is particularly advantageous in that the radio IC chip is protected from external shock and environmental change without affecting the planarity of the packaging material, the assembly of the radiator and the electromagnetic coupling module is facilitated, and the radiation characteristics are satisfactory.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A packaging material with an electromagnetic coupling module comprising:
a packaging material including a liner, and a core material connected to the liner;
an electromagnetic coupling module including a radio IC chip and a feeder circuit board on which the radio IC chip is mounted, the feeder circuit board including a resonant circuit that includes an inductance element and has a predetermined resonant frequency; and
a radiator electromagnetically coupled to the feeder circuit board; wherein
the radiator is arranged inside of the packaging material; and
the electromagnetic coupling module is arranged on the radiator or adjacent to the radiator inside of the packaging material.

2. The packaging material with the electromagnetic coupling module according to claim 1, wherein the radiator is a conductor having one of a linear shape, a wire shape, or a thin-film shape.

3. The packaging material with the electromagnetic coupling module according to claim 1, wherein the radiator is arranged in a direction parallel or substantially parallel to the core material.

4. The packaging material with the electromagnetic coupling module according to claim 1, wherein the radiator is arranged in a direction perpendicular or substantially perpendicular to the core material.

5. The packaging material with the electromagnetic coupling module according to claim 1, wherein the radiator is arranged on one main surface of the core material, and the electromagnetic coupling module is arranged on the other main surface.

6. The packaging material with the electromagnetic coupling module according to claim 1, wherein at least one of the radiator or the electromagnetic coupling module is arranged at a recessed portion of the core material.

7. The packaging material with the electromagnetic coupling module according to claim 1, wherein the radiator is interwoven in the core material.

8. The packaging material with the electromagnetic coupling module according to claim 1, wherein the radiator is arranged inside of the liner.

9. The packaging material with the electromagnetic coupling module according to claim 1, wherein at least one of the liner and the core material is made of paper.

10. The packaging material with the electromagnetic coupling module according to claim 1, wherein the liner is sheet-shaped.

11. The packaging material with the electromagnetic coupling module according to claim 1, wherein the core material is wave-shaped.

12. The packaging material with the electromagnetic coupling module according to claim 1, wherein the packaging material further includes another liner, and the core material is disposed between the liner and the another liner.
